(19) United States
(12) Patent Application Publication
(10) Pub. No.: US 2010/0034977 A1
(43) Pub. Date: Feb. 11, 2010

(54) SPRAY TYPE GRADATION SYSTEM AND METHOD OF OPERATING THE SAME

(75) Inventors: Il Jin Kim, Seoul (KR); Young Ki Kim, Seongnam-si (KR); Shin Chul Kang, Seoul (KR); Hoon Soo Park, Gwangmyeong-si (KR); Ho Soon Shin, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/533,621

(22) Filed: Jul. 31, 2009

(30) Foreign Application Priority Data
Aug. 5, 2008 (KR) 10-2008-0076265

(51) Int. Cl. B05D 1/36; B05B 1/14; B05D 1/02

(52) U.S. Cl. 427/402; 118/315; 427/425

(57) ABSTRACT

A spray type gradation system and method wherein an object to be painted is mounted in a jig unit including a rotation shaft. The jig is rotated to position the object to be painted in front of a coloring unit including a first spray gun and a second spray gun. The first and second spray guns spray paints to different portions of the object to be painted.

### PRIORITY

This application claims priority to an application entitled “SPRAY TYPE GRADATION SYSTEM AND METHOD OF OPERATING THE SAME”, which was filed in the Korean Intellectual Property Office on Aug. 5, 2008 and assigned Serial No. 10-2008-0076265, the contents of which are incorporated herein by reference.

### BACKGROUND OF THE INVENTION

1. Field of the Invention

The present invention relates generally to a spray type gradation system and method that enables a gradation effect when painting a product with a spray type paint, and more particularly, to a spray type gradation system and method that provides various colors when painting an external surface of a product such as a mobile electronic device.

2. Description of the Related Art

Various mobile electronic devices, such as mobile terminals, mobile phones, wired/wireless phones, portable multimedia players (PMPs), personal digital assistants (PDAs), and smart phones, are widely used throughout the world. Further, it has also become common for users to want various designs and/or colors for their mobile electronic devices.

Particularly, when creating an external appearance of a mobile electronic device such as a mobile phone, conventionally, equipment providing only one color has been used, with which it is impossible to provide two or more colors during a one-time painting operation, or to provide a gradation effect.

Conventional painting equipment for mobile phones use either a general spindle method or a super spindle method. In the general spindle method, a product is horizontally disposed in a jig and a spray gun is horizontally installed to spray in a direction parallel to the product, the entire length of the product is painted through horizontal movement of the jig. Therefore, in this type of operation, two or more colors cannot be painted in one operation.

In the super spindle method, a product is vertically disposed and a spray gun paints over the entire length of the product through vertical movement. Again, in this type of operation, two or more colors cannot be painted in one operation.

In order to provide two or more eternal colors on a mobile phone, or to provide a gradation effect, with a conventional technology, a method of separately performing digital printing or offset printing, after painting an external surface with one color has been used. However, with this type of method, the previous manufacture of a film to perform digital printing or offset printing is difficult and inappropriate for mass production.

### SUMMARY OF THE INVENTION

The present invention has been designed in view of the above and other problems occurring in the art, and provides a spray type gradation system and method for enabling a gradation effect of at least two on an external surface of a mobile electronic device during a one-time painting operation.

The present invention also provides a spray type gradation system and method that simplify a production process and reduce a production cost by directly painting onto an existing base color of a mobile electronic device without requiring an additional base coating process.

In accordance with an aspect of the present invention, a spray type gradation system is provided. The system includes: an object to be painted; a jig unit including a rotation shaft, a beam radially extended about an upper end of the rotation shaft, and a connection member, a first end of the connection member being connected to the beam, and a plate formed at a second end of each connection member for mounting the object to be painted; and a coloring unit including a support, two spray guns disposed at a position separated from the support, two fasteners, each fastener fixing one of the two spray guns to the support, two connection tubes, each connection tube being connected to one of the two spray guns, and two paint tanks, each paint tank being connected to one of the two connection tubes. The two spray guns spray paints to different portions of the object to be painted.

In accordance with another aspect of the present invention, a method of operating a spray type gradation system is provided. The method includes: receiving an object to be painted in a jig unit, the jig unit including a rotation shaft, a beam radially extended about an upper end of the rotation shaft, and a connection member, a first end of the connection member being connected to the beam, and a plate formed at a second end of the connection member for mounting the object to be painted;; rotating the rotation shaft, such that the object received in the jig unit passes by two spray guns; and spraying, by the two spray guns, paints to different portions of the object to be painted.

### BRIEF DESCRIPTION OF THE DRAWINGS

The above and other aspects, features, and advantages of the present invention will be more apparent from the following detailed description in conjunction with the accompanying drawings, in which:

FIG. 1 is a perspective view illustrating a configuration of a spray type gradation system according to an embodiment of the present invention;

FIG. 2 is an exploded perspective view illustrating a jig unit in the spray type gradation system illustrated in FIG. 1;

FIG. 3 illustrates a gradation effect of a product painted by the spray type gradation system illustrated in FIG. 1; and

FIG. 4 is a perspective view illustrating a configuration of a spray type gradation system according to an embodiment of the present invention.

### DETAILED DESCRIPTION OF EMBODIMENTS OF THE INVENTION

Hereinafter, embodiments of the present invention are described in detail with reference to the accompanying drawings. The same reference numbers are used throughout the drawings to refer to the same or like parts. The views in the drawings are schematic views only, and are not intended to be to scale or correctly proportioned. Detailed descriptions of well-known functions and structures incorporated herein may be omitted herein to avoid obscuring the subject matter of the present invention.

In the following description, for convenience of a description, a mobile phone is exemplified as a product to be painted, although the present invention is not limited thereto. That is, a product to be painted according to an embodiment of the present invention may be any mobile electric device (or any other type of object of a scale corresponding to a size of the spray system).

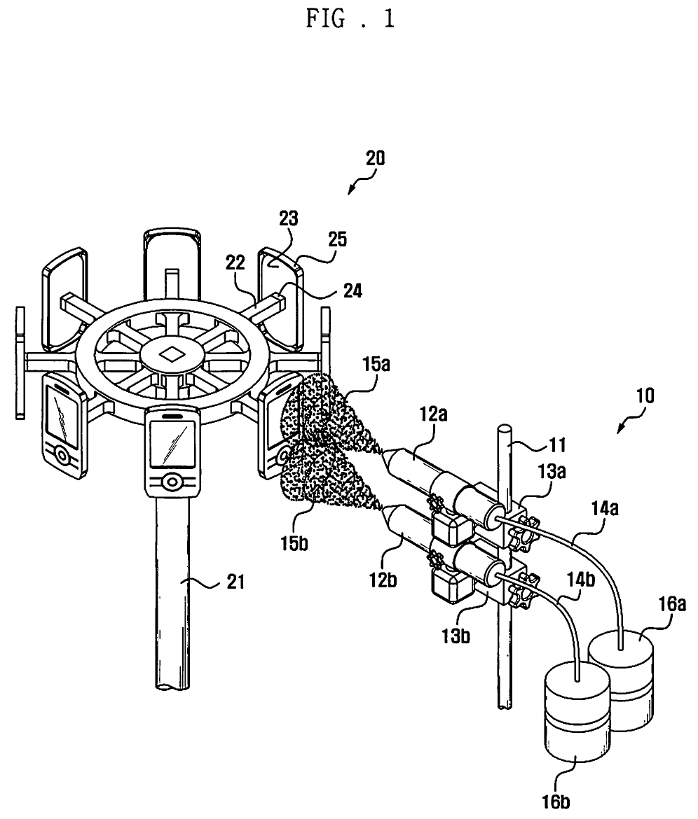

FIG. 1 is a perspective view illustrating a configuration of a spray type gradation system according to an embodiment of the present invention.

Referring to FIG. 1, the spray type gradation system includes a coloring unit 10 and a jig unit 20. The coloring unit 10 includes a support 11, and two spray guns 12a and 12b that positioned to spray objects 25 to be painted that are mounted in the jig unit 20. The coloring unit also includes two fasteners 13a and 13b for fixing the two spray guns 12a and 12b, respectively, to the support 11, two connection tubes 14a and 14b connected to the two spray guns 12a and 12b, respectively, and two paint tanks 16a and 16b, which are filled with paints 15a and 15b, respectively, connected to the two connection tubes 14a and 14b, respectively.

The jig unit 20 includes a rotation shaft 21, a plurality of beams 22 radially extended about an upper end of the rotation shaft 21, and a plurality of connection members 24. A first end of each connection member 24 is connected to one of the plurality of beams 22, and a second end of each connection member 24 is connected to a plate 23 for mounting one of the plurality of objects 25. Although the jig unit 20 includes eight beams 22, connection members 24, and plates 23, in FIG. 1, the jig unit 20 can be designed with as many or as few beams 22, connection members 24, and plates 23 as required is required for production needs and/or permitted by the size of the apparatus.

Preferably, the two spray guns 12a and 12b are vertically disposed at the support 11 through the two fasteners 13a and 13b. Using the two spray guns 12a and 12b, the paints 15a and 15b in the paint tanks 16a and 16b are sprayed to an upper part and a lower part, respectively, of a mobile phone case mounted on the plate 23. The paints 15a and 15b may have different colors, or one of the paints 15a and 15b may be transparent and the other opaque color.

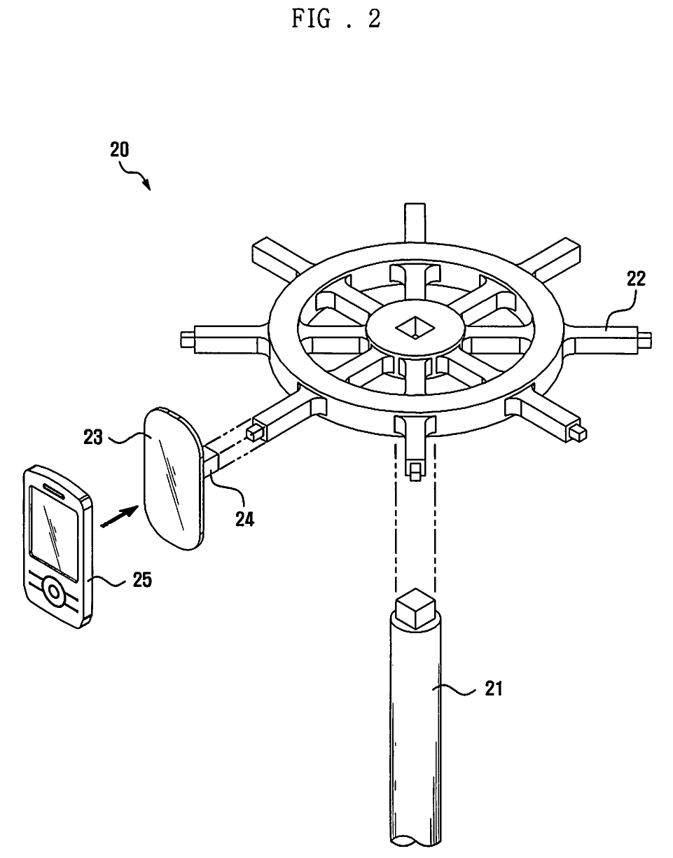

FIG. 2 is an exploded perspective view illustrating the jig unit 20 in the spray type gradation system illustrated in FIG. 1.

Referring to FIG. 2, the plurality of beams 22 are integrally formed and can rotate about the longitudinal axis of the rotation shaft 21. The rotation shaft 21 and the plurality of beams 22 may be integrally formed, and the plurality of connection members 24 may also be integrally formed with the rotation shaft 21 and the plurality of beams 22.

The plurality of connection members 24 are each used for installing a mobile phone case 25 at the jig unit 20 and are mounted at one end of the plurality of beams 22. Each plate 23 is perpendicular to a longitudinal axis of the corresponding beam 22 and supports the object, e.g., a mounted mobile phone case, 25. The mobile phone case 25 is thereby vertically mounted in the jig unit 20.

Referring back to FIG. 1, the two spray guns 12a and 12b are connected to the two paint tanks 16a and 16b through the two connection tubes 14a and 14b, respectively, and the two spray guns 12a and 12b are vertically disposed at the support 11 and separated by a predetermined gap through the two fasteners 13a and 13b. Spray holes of the two spray guns 12a and 12b face a painting surface of the mobile phone case 25 mounted in the jig unit 20. Therefore, the longitudinal axes of the support 11 and the mobile phone case 25 are parallel. By manipulating screws for coupling the two fasteners 13a and 13b and the support 11, a gap between the upper spray gun 12a and the lower spray gun 12b is adjusted according to the length of the mobile phone case 25. Preferably, a gap between the two spray guns 12a and 12b is smaller than the length of the mobile phone case 25.

The paints 15a and 15b are sprayed from the two spray guns 12a and 12b towards the mobile phone case 25. The rotation shaft 21 may continually rotate during the spraying, or may rotate to position the mobile phone case 25, prior to spraying. When spraying paints 15a and 15b is completed on one of the plurality of mobile phone cases 25, the jig unit 20 rotates another mobile phone case 25 in front of two spray guns 12a and 12b and the paints 15a and 15b are sprayed to the another mobile phone case 25. By repeating this process, the paints 15a and 15b are sequentially sprayed to the plurality of mobile phone cases 25.

When a transparent paint is sprayed from the upper spray gun 12a and color paint is sprayed from the lower spray gun 12b, a gradation effect of the color of the paint and the base color of the mobile phone case 25 can be obtained. In this case, conventionally, in order to perform color coating, base coating must first be performed on the mobile phone case and color coating is performed thereon. However, in accordance with an embodiment of the present invention, a base coating process is unnecessary.

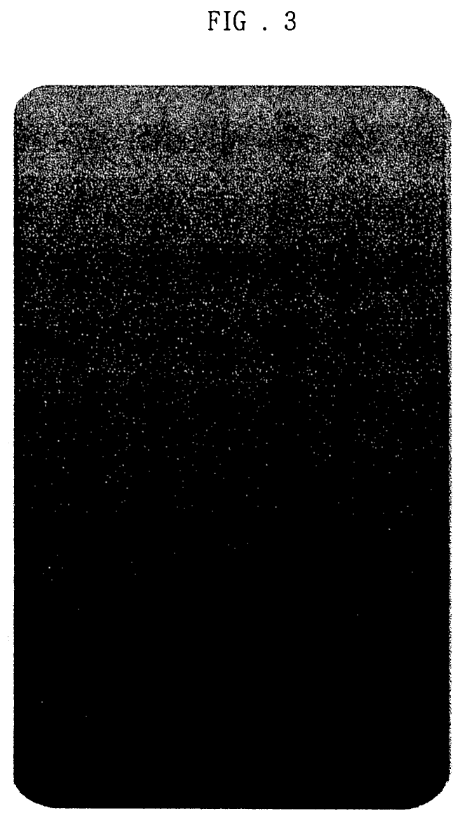

FIG. 3 illustrates a gradation effect of a product painted by the spray type gradation system illustrated in FIG. 1.

Referring to FIG. 3, an upper portion of the mobile phone case 25 painted by the spray type gradation system is coated with the paint 15a sprayed from the upper spray gun 12a, and a lower portion of the mobile phone case 25 is coated with the paint 15b sprayed from the lower spray gun 12b. In this case, the upper paint 15a and the lower paint 15b are mixed in an intermediate portion of the mobile phone case 25, and a transition portion is formed in which a color of the upper portion of the mobile phone case 25 coated by the upper paint 15a becomes darker in a direction towards the intermediate portion of the mobile phone case 25 and in which a color of the lower portion of the mobile phone case 25 coated by the lower paint 15b becomes darker in a direction towards the intermediate portion of the mobile phone case 25.

For example, when a transparent paint is sprayed from the upper spray gun 12a and a blue paint is sprayed from the lower spray gun 12b onto a mobile phone case 25 having a black base color, the paint finish is a blue color at a lower part of the mobile phone case 25 and becomes more black towards an upper part thereof, and is black at the upper part of the mobile phone case 25. Therefore, the mobile electronic device 25 can have a pleasing color gradation as well as various colors.

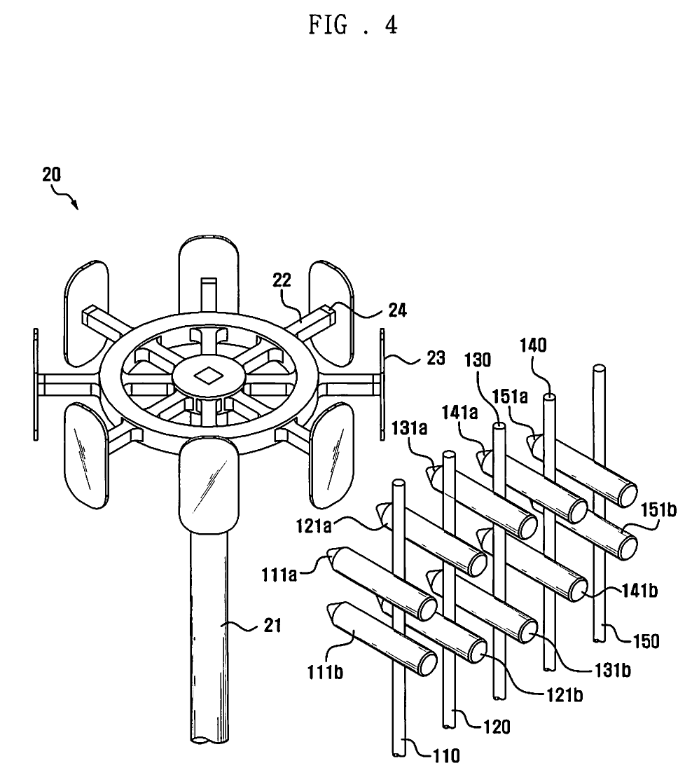

FIG. 4 is a perspective view illustrating a configuration of a spray type gradation system according to another embodiment of the present invention. More specifically, FIG. 4 illustrates a modified embodiment of FIG. 1, and therefore the elements of FIG. 4 that correspond to the previously described elements of FIG. 1 are not described again herein below.

Referring to FIG. 4, a plurality of coloring units 110, 120, 130, 140, and 150 are installed. The plurality of coloring units 110 to 150 are disposed in a line facing towards the jig unit 20. A method of fixing spray guns 111a and 111b, 121a and 121b, 131a and 131b, 141a and 141b, and 151a and 151b of the plurality of coloring units 110 to 150 to corresponding supports is similar to that of FIG. 1. Similarly to FIG. 1, each of the coloring units 110 to 150 includes corresponding paint tanks, connection tubes, and fasteners, although only the supports and spray guns are illustrated in FIG. 4, for ease of description.

A gap between the two spray guns of at least one of the coloring units 110 to 150, i.e., a gap between the upper spray gun 111a and the lower spray gun 111b of the first coloring unit 110, a gap between the upper spray gun 121a and the lower spray gun 121b of the second coloring unit 120, a gap between the upper spray gun 131a and the lower spray gun 131b of the third coloring unit 130, a gap between the upper spray gun 141a and the lower spray gun 141b of the fourth coloring unit 140, and a gap between the upper spray gun 151a and the lower spray gun 151b of the fifth coloring unit 150, may be different from each other in order to provide different gradient effects or coloring options.

Further, the paints sprayed from the upper spray guns 111a to 151a may have an identical color, and the paints sprayed from the lower spray guns 111b to 151b may have another identical color. Thereby, the mobile phone case can be evenly and completely painted.

As described above, according to the embodiments of the present invention, an external appearance of a product can have a gradation effect of two or more colors with a one-time painting operation, and therefore a product having an external appearance of two or more colors can be mass produced more efficiently.

When representing gradation with a transparent paint and a color paint, a base coating is unnecessary. Therefore, a process is simplified and a production cost can be reduced.

Further, by providing a plurality of coloring units, painting can be completely performed in fewer operations.

Although embodiments of the present invention have been described in detail hereinabove, it should be clearly understood that many variations and modifications of the basic inventive concepts herein described, which may appear to those skilled in the art, will still fall within the spirit and scope of the embodiments of the present invention as defined in the appended claims.

What is claimed is:

1. A spray type gradation system, comprising:
an object to be painted;
a jig unit including a rotation shaft, a beam radially extended about an upper end of the rotation shaft, and a connection member, a first end of the connection member being connected to the beam, and a plate formed at a second end of the connection member for mounting the object to be painted; and
a coloring unit including a support, a first spray gun, a second spray gun, two fasteners for fastening the first and second spray guns to the support, two connection tubes, each of the connection tubes being connected to one of the first and second spray guns, and two paint tanks, each of the paint tanks being connected to one of the two connection tubes,
wherein the first and second spray guns spray paints to different portions of the object to be painted.

2. The spray type gradation system of claim 1, wherein the first spray gun sprays a transparent paint and the second spray gun sprays color paint.

3. The spray type gradation system of claim 1, wherein the first and second spray guns spray different color paints.

4. The spray type gradation system of claim 1, wherein the object to be painted is vertically mounted in the jig unit.

5. The spray type gradation system of claim 1, wherein the first and second spray guns are horizontally disposed in the support.

6. The spray type gradation system of claim 1, further comprising a second coloring unit including a second support, a third spray gun, a fourth spray gun, two secondary fasteners for fastening the third and fourth spray guns to the second support, two secondary connection tubes, each of the secondary connection tubes being connected to one of the third and fourth spray guns, and two secondary paint tanks, each the secondary paint tanks being connected to one of the two secondary connection tubes,
wherein the third and fourth spray guns spray paints to different portions of the object to be painted.

7. The spray type gradation system of claim 6, wherein a gap between the first and second spray guns is different to than a gap between the third and fourth spray guns.

8. A method of operating a spray type gradation system, comprising:
receiving an object to be painted in a jig unit, the jig unit including a rotation shaft, a beam radially extended about an upper end of the rotation shaft, and a connection member, a first end of the connection member being connected to the beam, and a plate formed at a second end of the connection member for mounting the object to be painted;
rotating the rotation shaft such that the jig unit rotates the object to be painted in front of a first spray gun and a second spray gun; and
spraying, by the first and second spray guns, paints to different portions of the object to be painted.

9. The method of claim 8, further comprising:
receiving another object to be painted in the jig unit, the jig unit further including a second beam radially extended about the upper end of the rotation shaft, and a second connection member, a first end of the second connection member being connected to the second beam, and a second plate formed at a second end of the second connection member for mounting the another object to be painted;
rotating the rotation shaft such that the jig unit rotates the another object to be painted in front of the first spray gun and the second spray gun; and
spraying, by the first and second spray guns, the paints to different portions of the another object to be painted.

10. The method of claim 8, wherein the first spray gun sprays a transparent paint and the second spray gun sprays a color paint.

11. The method of claim 8, wherein the first and second spray guns spray different color paints.

12. The method of claim 8, wherein the object to be painted is vertically mounted in the jig unit.

13. The method of claim 8, wherein the first and second spray guns are horizontally disposed in the support.
